(19) United States
(12) Patent Application Publication
(10) Pub. No.: US 2013/0185653 A1
(43) Pub. Date: Jul. 18, 2013

(54) SYSTEM AND METHOD FOR PROVIDING MULTIMEDIA COMPILATION GENERATION

(71) Applicants: Carlos Cantu, III, The Woodlands, TX (US); David Thomas Seeburger, Houston, TX (US)

(72) Inventors: Carlos Cantu, III, The Woodlands, TX (US); David Thomas Seeburger, Houston, TX (US)

(21) Appl. No.: 13/741,437

(22) Filed: Jan. 15, 2013

Related U.S. Application Data
(60) Provisional application No. 61/586,794, filed on Jan. 15, 2012.

(51) Int. Cl. H04L 29/06

(52) U.S. Cl. CPC H04L 65/403
USPC 715/753

(57) ABSTRACT

The present invention generally relates to generation of compilations. Specifically, this invention relates to a computer implemented system and method for providing users the ability to generate a multimedia compilation (e.g., biography) and provide the multimedia compilation to one or more individuals in one or more physical and/or digital formats.

### CROSS-REFERENCE TO RELATED APPLICATIONS

This application claims the benefit of U.S. Provisional Patent Application No. 61/586,794 filed Jan. 15, 2012, the entire disclosure of which is incorporated herein by reference.

### FIELD OF THE INVENTION

The present invention generally relates to generation of compilations. Specifically, this invention relates to a computer implemented system and method for providing users the ability to generate a multimedia compilation (e.g., biography) and provide the multimedia compilation to one or more individuals in one or more physical and/or digital formats.

### BACKGROUND OF THE INVENTION

Keeping records of family histories or otherwise preserving the works of individuals or groups has been a tradition in most cultures. Preserving these moments is a time honored tradition, with generations passing down heirlooms, paintings, photographs and other visual, audio and multimedia content associated with their loved ones or those who have been respected, vilified, revered or otherwise worthy of remembrance.

Modern technologies have allowed the general public to create and store information and materials about their loved ones in electronic and other digital and analog formats that allow for preservation of these materials for indefinite or nearly indefinite time periods. While these content forms provide indefinite storage and retrieval possibilities, a secondary problem has arisen, in the form of too much content and information. Now that every device has a camera and a microphone capable of recording imagery, video and audio data, the amount of data about any individual is so vast that it can become difficult to sort and organize in a the content into an appropriate format for consumption.

With respect to biographies in particular, given the amount of content now available regarding certain individuals, it becomes increasingly difficult to sort through the content to find and format the high quality content from the low quality content. Professional biographers can be hired, but the expense of a personal biographer is exclusionary and not accessible to the general public. Biographies, and other forms of compilations, can be done by non-professionals, but usually the quality suffers and the time spent creating the compilation/biography is much greater than what it otherwise needs to be.

Finally, once a compilation has been completed, generation and delivery of the final product in one or more mediums is an additionally complex task. Using commercial software and hardware, an individual does have the ability to “burn” a DVD, but the same user has no way to generate high quality finished products capable of being delivered and received by end users efficiently.

Therefore there is a need in the art for a system and method for providing users the ability to easily generate a multimedia compilation and provide the multimedia compilation to one or more individuals in one or more physical and/or digital forms. These and other features and advantages of the present invention will be explained and will become obvious to one skilled in the art through the summary of the invention that follows.

### SUMMARY OF THE INVENTION

Accordingly, it is an object of the present invention to provide a system and method for providing users the ability to easily generate a multimedia compilation and provide the multimedia compilation to one or more individuals in one or more physical and/or digital forms.

According to an embodiment of the present invention, a computer implemented system for generating multimedia compilations includes: an interview module comprising computer-executable code stored in non-volatile memory; a media generation module comprising computer-executable code stored in non-volatile memory; a processor; and a communications means, wherein the interview module, the media generation module, the processor, and the communications means are operably connected and are configured to: receive an interview request from a first user; generate a selection of questions based on interactions with the first user; generate an interview design and format based on interactions with the first user; receive interview content from the first user; analyze the interview content; process the interview content; and transmit a final multimedia compilation, wherein the final multimedia compilation is based at least in part on the interview content.

According to an embodiment of the present invention, the final multimedia compilation is transmitted to one or more recipients other than the first user.

According to an embodiment of the present invention, the interview module, the media generation module, the processor, and the communications means are further configured to receive interview content from a second user.

According to an embodiment of the present invention, the media generation module, the processor, and the communications means are further configured to generate hardcopies of the final multimedia compilation.

According to an embodiment of the present invention, the media generation module, the processor, and the communications means are further configured to send the hardcopies of the final multimedia compilation to one or more recipients.

According to an embodiment of the present invention, the media generation module, the processor, and the communications means are further configured to provide an access link to the final multimedia compilation, wherein one or more recipients are provided the access link and the access link provides the one or more recipients the ability to receive the final multimedia compilation.

According to an embodiment of the present invention, the processing of the interview content includes processing and formatting video content for quality purposes.

According to an embodiment of the present invention, the processing of the interview content includes processing and formatting audio content for quality purposes.

According to an embodiment of the present invention, the processing of the interview content includes processing and formatting textual content for quality purposes.

According to an embodiment of the present invention, the processing of the interview content includes processing and formatting graphic content for quality purposes.

According to an embodiment of the present invention, a computer implemented method for generating multimedia compilations includes the steps of: receiving an interview request from a first user; generating a selection of questions based on interactions with the first user; generating an interview design and format based on interactions with the first user; receiving interview content from the first user; analyzing the interview content; processing the interview content; and transmitting a final multimedia compilation, wherein the final multimedia compilation is based at least in part on the interview content.

According to an embodiment of the present invention, the method further includes the step of transmitting the final multimedia compilation to one or more recipients other than the first user.

According to an embodiment of the present invention, the method further includes the step of receiving interview content from a second user.

According to an embodiment of the present invention, the method further includes the step of generating hardcopies of the final multimedia compilation.

According to an embodiment of the present invention, the method further includes the step of sending the hardcopies of the final multimedia compilation to one or more recipients.

According to an embodiment of the present invention, the method further includes the step of providing an access link to the final multimedia compilation, wherein one or more recipients are provided the access link and the access link provides the one or more recipients the ability to receive the final multimedia compilation.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a network schematic of a system, in accordance with an embodiment of the present invention;

FIG. 2 illustrates a schematic overview of a computing device, in accordance with an embodiment of the present invention;

FIG. 3 is an exemplary embodiment of a web-based system in accordance with an embodiment of the present invention; and

FIG. 4 is a flowchart of an exemplary method in accordance with an embodiment of the present invention.

### DETAILED SPECIFICATION

The present invention generally relates to generation of compilations. Specifically, this invention relates to a computer implemented system and method for providing users the ability to generate a multimedia compilation (e.g., biography) and provide the multimedia compilation to one or more individuals in one or more physical and/or digital formats.

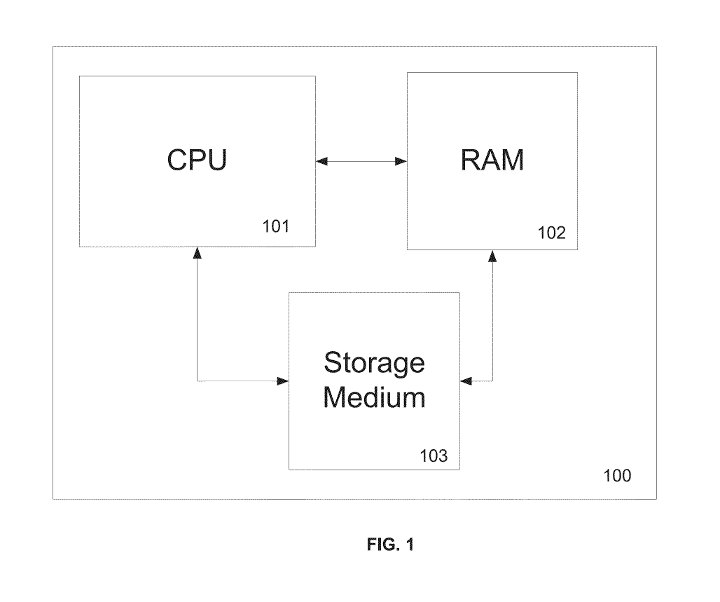

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

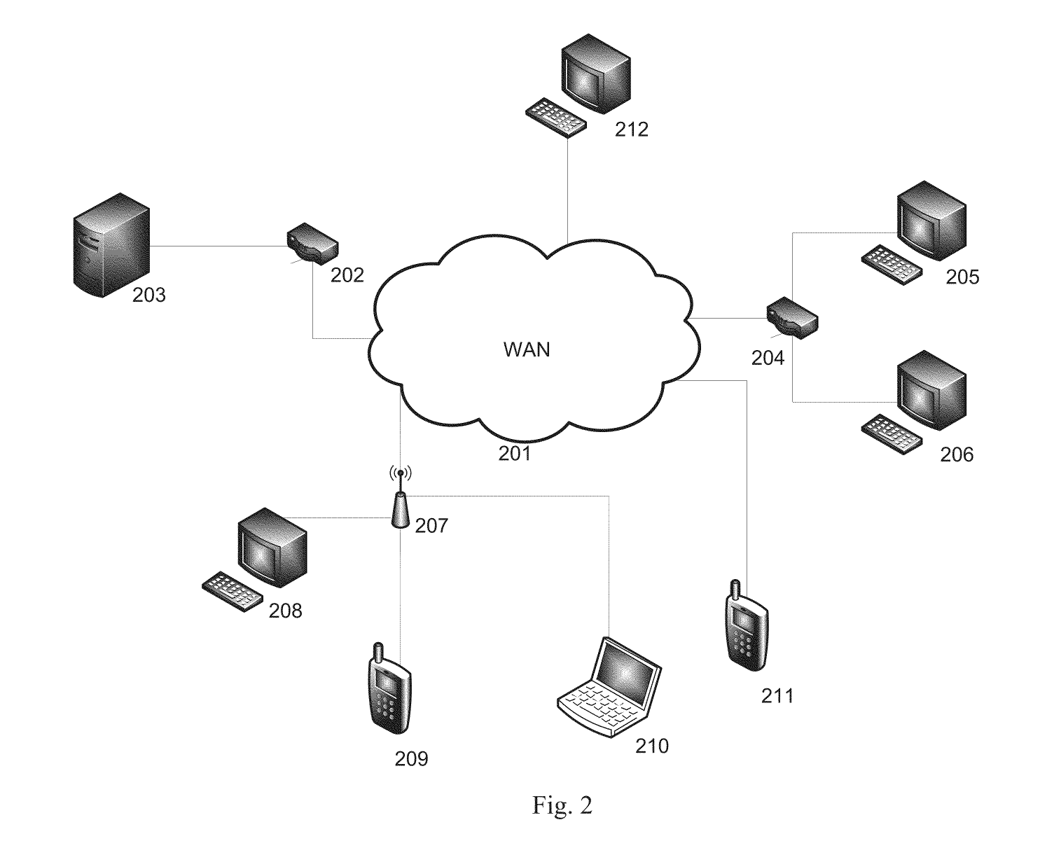

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to. While many components of the system are web-based or otherwise utilize computing devices over networks, such as the internet, certain aspects of the invention may be provided by analog systems (e.g., landline telephones could be utilized to call and leave voicemails which may be digitized and converted into useable components within the system).

According to an embodiment of the present invention, the system is configured to provide users the ability to generate a multimedia compilation (e.g., biography) and provide the multimedia compilation to one or more individuals in one or more physical and/or digital formats. In achieving this functionality, the system is configured to prepare a user to perform a customized interview by collecting personal information, providing one or more questions from a question bank, one or more templates that allows for inclusion of pictures, and the ability to choose from a number of stylistic parameters.

According to an embodiment of the present invention, the question bank is stored by the system, locally, remotely or some combination thereof. The system is configured to retrieve one or more questions from the question bank and present the questions to the user for selection and potential use in the interview. In this manner, the user pre-selects the set of questions to be asked and answered in the interview. The user may also choose a standardized set of questions. The system may be further configured to select or present one or more additional questions based on selections made by the user. For instance, if the user selects a question A that has natural follow up questions B and C associated with it, the system may be configured to present follow up questions B and C as potential interview questions as well. The system may be configured to automatically select questions based on the user's demographic, background, and personal history.

According to an embodiment of the present invention, templates provided by the system are configured to assist the user with the design and over all look and feel of the final compilation (e.g., biography). Content utilized to create the final compilation may be gathered from the user or selected from stock content stored locally or remotely at the system. The system is configured to use templates to convert the raw compilation into a professional quality design. Templates may be further personalized through the use of user content in order to make the final product tailored to the interviewee. During this design process, the system may generate a timeline for conducting the interview to assist the user during the interview.

According to an embodiment of the present invention, once the user has finished organizing the interview the user may conduct the interview with the interviewee or interviewees. The system is configured to assist and guide the interview process. First, the system is configured to instruct the user and interviewee how to set the stage for the interview. Second, the system is configured to guide the actual interview process using the timeline generated during the previous phase as described above. For clarity sake, it is possible that the “user” and “interviewee” could be the same person.

According to an embodiment of the present invention, the user and interviewee conduct the interview through the system by connecting to the system using a computing device (e.g., laptop, desktop) equipped with the appropriate hardware (e.g., microphone, video recording device). In a preferred embodiment of the present invention, the system is configured to assist the user and interviewee in making sure the video, audio and other aspects are properly configured prior to conducting the interview. For instance, the system may be configured to help the user and the interviewee align the camera properly, check lighting characteristics, check audio quality and levels or any combination thereof. One of ordinary skill in the art would appreciate that there are numerous characteristics the system may be configured to test in accordance with embodiments of the present invention, and embodiments of the present invention are contemplated for use with any testing method/procedure. Further, in preferred embodiments of the present invention, the system is configured to provide these features without requiring the system to download or install any software to the computing device of the user or interviewee, making system requirements negligible and the need for configuration of the user's or interviewee's computing device irrelevant. Alternate embodiments or particular components of certain embodiments, especially mobile applications, may be enhanced by requiring the installation of additional software or applications (e.g., a mobile application installed on a smartphone).

According to an embodiment of the present invention, as the interview progresses the system is configured to automatically, or at the direction of the user, advance through the questions selected for the interview. For each question, the system may be configured to note the start time and end time for the beginning and end of each question/response combination as well as other characteristics of the video clip during that time for use later during the editing process. These characteristics may include, but are not limited to, duration, time uploaded and person uploading. Duration and other detectable elements may be utilized by the system later during the automated processing features as described below. One of ordinary skill in the art would appreciate that there are numerous characteristics that could be utilized with embodiments of the present invention, and embodiments of the present invention are contemplated for use with any appropriate characteristic.

According to an embodiment of the present invention, once the interview is complete, the system may be configured to provide the user and/or the interviewee the ability to review the rough video before submitting the video for automatic assembly. In this manner, if the user and/or interviewee are unhappy with the take, they can delete or redo some or all of the interview. At this stage, the rough video may include loosely edited additional content such as pictures, audio, music or text.

According to an embodiment of the present invention, the system may be configured to utilize remote collaboration components, whereby content may be provided from multiple sources, rather than from a single user or the interviewee. Individuals will be able to log onto the system with computer, laptop, smartphone, tablet, or landline telephone to upload multiple types of media including realtime or recorded videos, pictures, text or audio messages. This content will be managed by the system and will be made available for use in the template and final compilation. For example, an uncle or an aunt can visit the site to add pictures to the system.

According to an embodiment of the present invention, the system is configured to utilize cutting edge web-based streaming video technology to record video that serves as the foundation of the compilation interview. In a preferred embodiment of the present invention, video recorded by the user's computing device is automatically streamed to the system for use in the production of the final compilation. In an alternate embodiment of the present invention, video may be recorded locally by the user's computing device and later sent or otherwise transmitted to the system for processing and use in production of the final compilation.

According to an embodiment of the present invention, Once the rough video has been approved by the user and/or interviewee, the system is configured to automatically edit the video in real-time (or near real time) into a final product. The video is edited to include, among other things, pictures, chapter headings, transitions and a DVD menu. One of ordinary skill in the art would appreciate that there are numerous details and data that may be added to the video during the editing process in accordance with embodiments of the present invention, and embodiments of the present invention are contemplated for use with any details or data.

According to an embodiment of the present invention, The editing is performed by tagging different types of media, including, but not limited to, text, pictures, video, audio messages and data so that media can be added to the interview at different times and placed into a meaningful sequence within the interview template. The system is configured to automatically add these tags (e.g., date, time, file type, person uploading). The system may be further configured to allow one or more users the ability to add additional tags. Further, the system is configured to allow multiple users to purposely collaborate on the same video.

According to an embodiment of the present invention, the system is configured to provide the final product to the users in both digital and physical formats. In certain embodiments, the system may provide only digital or only physical formats. Digital versions can be stored/shared/viewed online or from storage media. Physical formats are created through multistream DVD authoring and may be placed into custom, high quality packaging to keep for a lifetime.

According to an embodiment of the present invention, the system is configured to automatically process the multistream DVD authoring of the video. In this manner, the entire process may be completed through use of the system. In a preferred embodiment of the system, the process involves a web-based automated interface that does not require the need for an actual physical human interface. The system is configured to utilize software and provide one or more graphical user interfaces to perform the functions of a producer. For clarification, the multistream DVD authoring of the video will take place on a media server. This aspect of the software system is such that multiple DVD's can be authored simultaneously. This may or may not require a graphical user interface.

According to an embodiment of the present invention, the system is configured to utilize a mix of hardware and software to perform the editing functions automatically (i.e. all the arranging and re-arranging of the video, the addition of audio/visual transitions, the incorporation of photographs and other content). This processing is performed “behind the scenes” by the software and hardware of the system. In a preferred embodiment of the present invention, discreet parameters are provided into the software components and utilized to edit the video accordingly. For example: (1) if an interview response is less than 45 seconds, the fade-to-black transition between responses will be shorter (2-3 seconds) versus a response that is greater than 45 seconds; and (2) the length of time a photo appears on the screen will depend on the length of the response. The user doesn't have to perform this task at all, the system is configured to completely automate the processing of the video. In certain embodiments, the discreet parameters may be provided into the software components via hard coding, dynamic insertion, variable insertion, or any combination thereof. One of ordinary skill in the art would appreciate that there are numerous methods for providing variables to software components in accordance with embodiments of the present invention, and embodiments of the present invention are contemplated for use with any method for providing variables to software components.

### Exemplary Embodiments

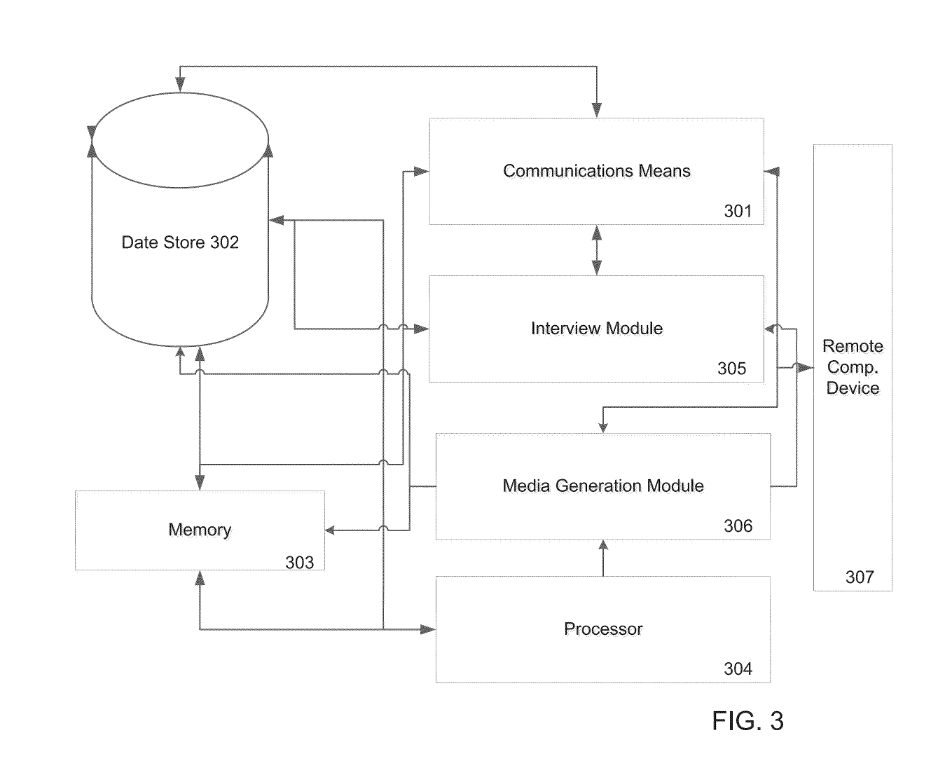

Turning now to FIG. 3, an exemplary embodiment of a web-based system in accordance with an embodiment of the present invention is shown. The system is comprised of a communications means 301 (e.g., wired connection, wireless connection, cellular connection), a data store 302 (e.g., database), a memory 303 (e.g., RAM, storage medium, cache memory), a processor 304 (e.g., CPU), an interview module 305 and a media generation module 306. While this embodiment identifies the aforementioned components, one of ordinary skill in the art would appreciate that fewer or greater number of components could be utilized with embodiments of the present invention. For instance, additional means may be included for connecting audio and visual hardware to the system (e.g., cameras, microphones).

According to an embodiment of the present invention, the communications means is configured to process the transmission and receipt of communications from a remote computing device 307. The remote computing device 307 could be, for instance, the mobile computing device or desktop/laptop PC of the user which is communicatively connected to the system via the communications means 301 through the transmission and receipt of data and other communications. One of ordinary skill in the art would appreciate that there are numerous types of communications means that could be utilized with embodiments of the present invention, and embodiments of the present invention are contemplated for use with any type of communications means.

According to an embodiment of the present invention, the interview module 305 is configured to interact and communicate with the user in order to provide the above described services, including, but not limited to, retrieval and provision of interview questions from the question bank, setup and analysis of the interview location/format, recordation and/or storage of multimedia content formed from the interview or provided by third-parties and processing of the multimedia content after approval. In order to achieve these functions, the interview module 305 may interact with one or more of the other components of the system, including the data store 302, memory 303 and processor 304.

According to an embodiment of the present invention, the media generation module 306 is configured to interact with the multimedia content and, optionally, the user, in order to process the multimedia content into an appropriate format for content delivery. For instance, he media generation module 306 may be configured to receive the raw interview multimedia content and process, format and index the multimedia content into a final format and then provide hardcopy processing (e.g., DVD, book, digital download, interactive software application based on the interview). In order to achieve these functions, the media generation module 306 may interact with one or more of the other components of the system, including the data store 302, memory 303 and processor 304.

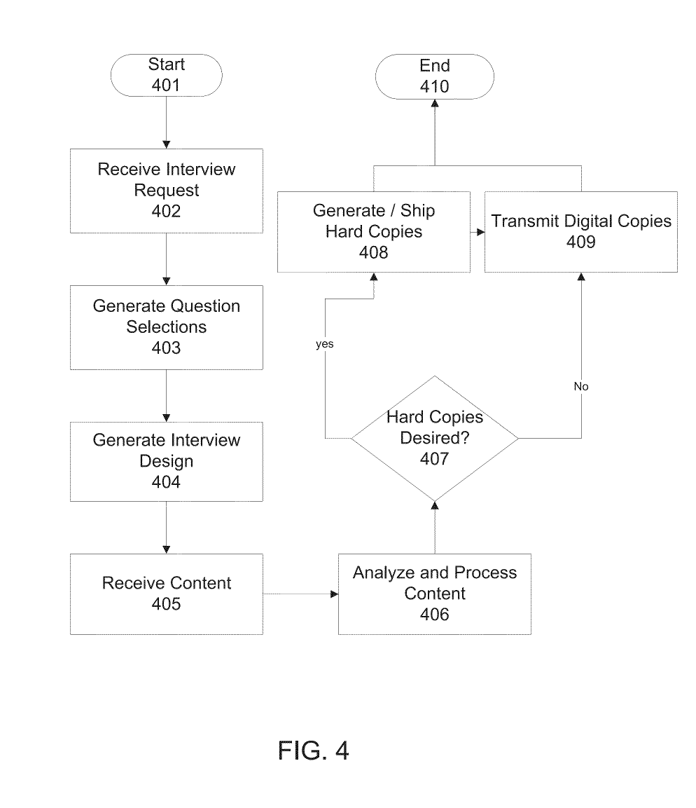

Turning now to FIG. 4, a flowchart of an exemplary method in accordance with an embodiment of the present invention is shown. The process starts at step 401 with the receipt of a request from a user for the provision of multimedia generation and compilation services. In a preferred embodiment, this request is received at a server or other computing device configured to provide web-based services via the Internet or other network.

At step 402, the system receives the request and identifies the request as an interview request. The system processes the relevant information associated with the request (e.g., user information, transaction type, interview parameters, content type desires). Once the system has processed the relevant information, the system begins to develop the interview.

At step 403, the system goes through the process outlined previously with regards to identifying questions for use in the interview and providing the user a guided experience through the selection process. Once the questions are formalized, the system generates a final selection of interview questions to be used in the compilation. In a preferred embodiment, the questions of the question bank are stored in a database associated with the system and both template and original questions may be utilized in the generation of the interview questions.

At step 404, the system analyzes data is has at its disposal about the interview (e.g., interview type, interview location, interview duration) and generates an interview design and format for use by the user during the interview. As noted previously, the system may help the user accomplish the interview design by one or more peripherals at its disposal (e.g., attached camera to detect lighting quality). Once the interview design is achieved to the satisfaction of the user and the system, the user will conduct the interview and record, either independently or in conjunction with the system, the multimedia content for use in the multimedia compilation.

At step 405, the multimedia content is received by the system, either by way of the system receiving one or more data transmissions from the user or if the system was handling the recording of the multimedia content, then receipt is simply by way of transferring data via the connection means to one or more processing components of the system. In certain embodiments, content may also be provided by third-parties at this point.

At step 406, the system analyzes the content for quality, format, acceptability for purpose and if the system deems the content acceptable, the system processes the content in any number of ways, including, but not limited to, processing audio data for quality (e.g., noise reduction, compression, equalization, loudness, dead air trimming), processing video data for quality (e.g., cutting dear air/empty frames, increase/decrease gamma/lighting, contrast correction, color correction, curing motion blur, upsampling/downsampling), processing for text quality (e.g., grammar correction, spelling correction, formatting, font changing/adapting) or any other form of processing required to get the multimedia compilation into a professional format. In general, all of these processing features can be automated by a combination of hardware and software configured to direct the hardware in order to process the content.

At step 407, the system determines if hard copies of the finalized multimedia compilation are desired. If yes, the system generates the appropriate hard copies (e.g., DVDs, Blu-Ray Disc, picture books) and in some embodiments, the system can be configured to package and ship the hard copies as well. Generation of the hard copies, as well as packaging and shipping, may require the integration of additional hardware and software components configured to instruct the hardware to accomplish these tasks. Additional hardware may include automated media presses and automated packaging systems known in the art.

If digital copies are desired, the system proceeds to step 409 (whether hard copies were also desired or not). At step 409, the system transmits the final product in one or more digital forms (e.g., MP4, ISO, AVI, WAV, MP3) to the appropriate recipients identified by the user. In an alternative to transmission, the system may provide download links or other identifiers where the identifier is provided to the individuals of user's choosing and the individuals can use the identifier to find and download the final multimedia compilation.

At step 410, the process terminates.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented system for generating multimedia compilations, the system comprising:
an interview module comprising computer-executable code stored in non-volatile memory;
a media generation module comprising computer-executable code stored in non-volatile memory;
a processor; and
a communications means,
wherein said interview module, said media generation module, said processor, and said communications means are operably connected and are configured to:
receive an interview request from a first user;
generate a selection of questions based on interactions with said first user;
generate an interview design and format based on interactions with said first user;
receive interview content from said first user;
analyze said interview content;
process said interview content; and
transmit a final multimedia compilation, wherein said final multimedia compilation is based at least in part on said interview content.

2. The system of claim 1, wherein said final multimedia compilation is transmitted to one or more recipients other than the first user.

3. The system of claim 1, wherein said interview module, said media generation module, said processor, and said communications means are further configured to receive interview content from a second user.

4. The system of claim 1, wherein said interview module, said media generation module, said processor, and said communications means are further configured to generate hardcopies of said final multimedia compilation.

5. The system of claim 4, wherein said interview module, said media generation module, said processor, and said communications means are further configured to send said hardcopies of said final multimedia compilation to one or more recipients.

6. The system of claim 1, wherein said interview module, said media generation module, said processor, and said communications means are further configured to provide an access link to said final multimedia compilation, wherein one or more recipients are provided said access link and said access link provides said one or more recipients the ability to receive said final multimedia compilation.

7. The system of claim 1, wherein said processing of said interview content includes processing and formatting video content for quality purposes.

8. The system of claim 1, wherein said processing of said interview content includes processing and formatting audio content for quality purposes.

9. The system of claim 1, wherein said processing of said interview content includes processing and formatting textual content for quality purposes.

10. The system of claim 1, wherein said processing of said interview content includes processing and formatting graphic content for quality purposes.

11. A computer implemented method for generating multimedia compilations, the method comprising the steps of:
receiving an interview request from a first user;
generating a selection of questions based on interactions with said first user;
generating an interview design and format based on interactions with said first user;
receiving interview content from said first user;
analyzing said interview content;
processing said interview content; and
transmitting a final multimedia compilation, wherein said final multimedia compilation is based at least in part on said interview content.

12. The method of claim 11, further comprising the step of transmitting said final multimedia compilation to one or more recipients other than the first user.

13. The method of claim 11, further comprising the step of receiving interview content from a second user.

14. The method of claim 11, further comprising the step of generating hardcopies of said final multimedia compilation.

15. The method of claim 14, further comprising the step of sending said hardcopies of said final multimedia compilation to one or more recipients.

16. The method of claim 11, further comprising the step of providing an access link to said final multimedia compilation, wherein one or more recipients are provided said access link and said access link provides said one or more recipients the ability to receive said final multimedia compilation.

17. The method of claim 11, wherein said processing of said interview content includes processing and formatting video content for quality purposes.

18. The method of claim 11, wherein said processing of said interview content includes processing and formatting audio content for quality purposes.

19. The method of claim 11, wherein said processing of said interview content includes processing and formatting textual content for quality purposes.

20. The method of claim 11, wherein said processing of said interview content includes processing and formatting graphic content for quality purposes.
